(19) United States
(12) Patent Application Publication
(10) Pub. No.: US 2024/0069558 A1
(43) Pub. Date: Feb. 29, 2024

(54) AUTONOMOUS ELECTRIC VEHICLE CHARGING ROBOT

(71) Applicant: The Energy Company, LLC, San Diego, CA (US)

(72) Inventor: Ahmed Owiess, San Diego, CA (US)

(21) Appl. No.: 18/239,024

(22) Filed: Aug. 28, 2023

Related U.S. Application Data
(60) Provisional application No. 63/402,025, filed on Aug. 29, 2022.

(51) Int. Cl. G05D 1/02; B60L 53/53; B60Q 1/50; B62D 5/04

(52) U.S. Cl. CPC G05D 1/0225; B60L 53/53; B60Q 1/543; B62D 5/046; G05D 1/0231

(57) ABSTRACT

A mobile system and/or apparatus for charging electric vehicle batteries may include a docking port, a vision module, a battery module including a battery to store electrical power to charge an electric vehicle battery, a drive module, and a control module to perform operations including controlling one or more other modules to electrically connect the docking port to a charging hub 156 at a first location, charge the battery with the charging hub 156, navigate and move between the charging hub 156 at the first location and a charging pillar 158 at a second location remote from the first location, electrically connect the robot apparatus to the charging pillar 158, and charge the electric vehicle battery. The vision module may include one or more sensors to detect objects in an area surrounding the mobile system. The drive module may include one or more drive wheels and a motor connected to each drive wheel.

### CROSS-REFERENCE TO RELATED APPLICATIONS

The present application claims priority to and benefit of U.S. Provisional Patent Application No. 63/402,025, filed Aug. 29, 2023, and entitled “SYSTEM AND APPARATUS FOR AUTOMATED CHARGING OF ELECTRIC VEHICLES,” the entirety of which is herein incorporated by reference.

### FIELD

The present disclosure relates to the field of electric vehicle charging. And, more particularly, to autonomous moving robots that are not directly connected to a power grid while charging electric vehicles.

### BACKGROUND

With increased adoption of electric vehicles (EVs), the need for support infrastructure for such vehicles has increased with industry demand. In particular, charging facilities have been deployed to many locations such as, for example, shopping centers, shopping malls, movie theaters, airports, and stadiums, to support EV charging at these locations. Customers with EVs can visit these locations and can simultaneously charge their EV. Charging facilities are integrated into these various locations by installing charging points in certain parking spaces, with each charging point typically being connected to an electrical power source such as, for example, a utility power grid. Moreover, as the total number of charging points in the charging facility may be limited, the parking spaces having charging points are typically specifically designated for EVs.

### SUMMARY

Existing conventional charging facilities must typically be connected to a power grid. Accordingly, the location of charging facilities and the EV charging points within the charging facility are often limited to locations such as, for example, near buildings or on edges of parking areas where the charging points can be connected to the power grid while minimizing the impact on other areas during both installation and operation. The costs associated with connecting each EV charging point in a charging facility to the power grid can limit the number of charging points a charging facility may provide. Furthermore, placing a charging point at a location often involves converting a parking space to a designated charging point, thereby reducing the number of parking spaces available for customers that do not require EV charging services.

When charging their EV at the charging facility, customers leave their EV parked in one of a limited number of available spaces having a charging point and charge their EV with the charging point. However, customers may leave their EV in one of the limited available spaces for a time period beyond the charging cycle of the EV while visiting other attractions at or near the location of the charging facility. For example, the charging facility may be located in a parking lot of a restaurant where the time period for the customer to dine at the restaurant exceeds the charge cycle of the EV. This creates inefficiencies such as a reduction in available charging points for other EVs in need of charging and loss of potential revenue. Thus, there is an unmet need for charging systems that can allow charging capabilities to be provided to parked EV vehicles when needed, but which still provide regular parking locations when charging is not needed.

Example implementations of the present application may meet these unmet needs, though solving these unmet needs is not a requirement of the present application.

In some embodiments, a robot apparatus includes a docking port, a vision module, a battery module including a battery configured to store electrical power to charge an electric vehicle battery, a drive module including one or more drive wheels, and one or more motors, each motor of the one or more motors is connected to a drive wheel of the one or more drive wheels, and a control module including a processor, and a non-transitory computer readable medium having stored thereon instructions executable by the processor to perform operations including control one or more other modules of the robot apparatus.

In some embodiments, the control module controls the one or more other modules of the robot apparatus to perform operations including electrically connect the docking port to a charging hub 156 at a first location, charge the battery with the charging hub 156, navigate and move between the charging hub 156 at the first location and a charging pillar 158 at a second location remote from the first location, electrically connect the robot apparatus to the charging pillar 158, and discharge the battery to charge the electric vehicle battery.

In some embodiments, the vision module includes one or more sensors. In some embodiments, the one or more sensors are configured to emit light pulses and detect objects in an area surrounding the robot apparatus based on the emitted light pulses. In other embodiments, the one or more sensors includes one or more cameras configured to capture images of a scene of an area surrounding the robot apparatus to detect for objects.

In some embodiments, the drive module further includes a drive battery, the drive battery powers the drive module, vision module, and control module to enable the robot apparatus to move between a charging hub 156 and a charging pillar 158 when the battery in the battery module is depleted. In some embodiments, the drive module further includes a motor controller, the one or more drive wheels includes a first drive wheel, and a second drive wheel, and the one or more motors includes a first motor connected to the first drive wheel, and a second motor connected to the second drive wheel, and the motor controller controls operation of the first motor and the second motor to enable the robot apparatus to move in one or more directions and to turn within a turning envelope. In some embodiments, the drive module further includes one or more caster wheels, the one or more caster wheels enables the robot apparatus to turn with a reduced turning envelope. In some embodiments, the one or more caster wheels includes a first pair of caster wheels located on a first side of a drive axis defined by the first drive wheel and the second drive wheel, and a second pair of caster wheels located on a second side of the drive axis opposite the first side.

In some embodiments, an energy delivery device includes a docking port, a vision module including one or more sensors configured to detect for objects in an area surrounding the energy delivery device, a battery module including a battery, the battery is electrically connected with the docking port and the battery is configured to store electrical power to charge an electric vehicle battery, a drive module including a motor controller, one or more drive wheels, and one or more motors, each motor of the one or more motors is connected to a drive wheel of the one or more drive wheels, and a control module including a processor, and a non-transitory computer readable medium having stored thereon instructions executable by the processor to control an operation of the energy delivery device and to perform operations including electrically connect the docking port to a charging hub 156 at a first location, charge the battery with the charging hub 156, navigate and move between the charging hub 156 at the first location and a charging pillar 158 at a second location remote from the first location, electrically connect the energy delivery device to the charging pillar 158, and discharge the battery to charge the electric vehicle battery.

In some embodiments, the one or more sensors are configured to emit light pulses and detect the objects in the area surrounding the energy delivery device based on the emitted light pulses. In some embodiments, the one or more sensors includes one or more cameras configured to capture images of a scene of the area surrounding the energy delivery device to detect for the objects.

In some embodiments, the control module further performs operations including obtain electrical signal data from the one or more sensors and identify one or more objects based on the electrical signal data.

In some embodiments, the drive module further includes a drive battery, the drive battery powers the drive module, vision module, and control module to enable the energy delivery device to move between the charging hub 156 and the charging pillar 158 when the battery in the battery module is depleted.

In some embodiments, the one or more drive wheels includes a first drive wheel, and a second drive wheel, and the one or more motors includes a first motor connected to the first drive wheel, and a second motor connected to the second drive wheel, the motor controller controls operation of the first motor and the second motor to enable the energy delivery device to move in one or more directions and to turn within a turning envelope.

In some embodiments, the drive module further includes a first pair of caster wheels located on a first side of a drive axis defined by the first drive wheel and the second drive wheel, and a second pair of caster wheels located on a second side of the drive axis opposite the first side, the caster wheels enable the energy delivery device to turn with a reduced turning envelope.

In some embodiments, the energy delivery device further includes an LED matrix, and the control module selectively illuminates the LED matrix and based on selectively illuminating the LED matrix, the control module signals a wake-up state, a moving state, a looking state, a turning state, a charging state, and a low battery state.

In some embodiments, a robot system for moving between a plurality of locations for charging an electric vehicle battery, the robot system includes a vision module including one or more sensors, a battery module including a battery including a plurality of battery packs arranged in one or more layers configured to store electrical power to charge the electric vehicle battery, a drive module to move the robot system between a first location and a second location including a first drive wheel, a second drive wheel, a first motor connected to the first drive wheel, a second motor connected to the second drive wheel, and one or more caster wheels, the one or more caster wheels enables the robot system to turn with a reduced turning envelope, and a control module, the control module performs operations including controlling one or more other modules to enable the robot system to move between the first location and the second location and to charge the electric vehicle battery, the robot system includes a docking port configured to electrically connect the battery to a charging hub 156 at the first location to charge the battery and to a charging pillar 158 at the second location to charge the electric vehicle battery.

In some embodiments, the drive module further includes a motor controller, the motor controller controls an operation of each drive assembly to provide a driving force to enable the robot system to move between the first location and the second location, and a drive battery, the drive battery powers the drive module, vision module, and control module to enable the robot system to move between the charging hub 156 and the charging pillar 158 when the battery in the battery module is depleted.

In some embodiments, the robot system further includes an LED matrix, the control module selectively illuminates the LED matrix and based on selectively illuminating the LED matrix, the control module signals a wake-up state, a moving state, a looking state, a turning state, a charging state, and a low battery state.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 illustrates a block diagram of a non-limiting example of a system, according to some embodiments.

FIG. 2 illustrates a block diagram of a non-limiting example computing environment of the system, according to some embodiments.

FIG. 3 illustrates a first perspective view of the system, according to some embodiments.

FIG. 4 illustrates a second perspective view of the system, according to some embodiments.

FIG. 5 illustrates a partially exploded view of the system, according to some embodiments.

FIG. 6 illustrates a front view of the system, according to some embodiments.

FIG. 7 illustrates a rear view of the system, according to some embodiments.

FIG. 8 illustrates a bottom view of the system, according to some embodiments.

FIG. 9 illustrates a top perspective view of a portion of the system, according to some embodiments.

FIG. 10 illustrates a bottom perspective view of the portion of the system, according to some embodiments.

FIG. 11 illustrates a bottom view of the portion of the system, according to some embodiments.

FIG. 12 illustrates an exposed side view of the portion of the system, according to some embodiments.

FIG. 13 illustrates an exposed perspective view of the system, according to some embodiments.

FIG. 14 illustrates a perspective view of a portion of the system, according to some embodiments.

FIG. 15 illustrates an exposed perspective view of the portion of the system, according to some embodiments.

FIG. 16 illustrates a perspective view of a top portion of the system, according to some embodiments.

FIG. 17 illustrates a top view of the system, according to some embodiments.

FIG. 18 illustrates a flow diagram of a method, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Various embodiments of the present disclosure may relate to systems, devices, and apparatuses for autonomous charging robots (ROS) including a high capacity energy storage system therein. The ROS being configured to electrically connect to a charging hub 156 at a first location to receive energy from the charging hub 156, store the energy in the onboard high capacity energy storage system, autonomously navigate to a charging pillar 158 at a second location to deliver the charged energy storage system, electrically connect to the charging pillar 158 and provide the stored energy from the high capacity energy storage system to the charging pillar 158, the charging pillar 158 being configured to dispense the energy to the energy storage system of an electric vehicle (“EV”). Other features of the ROS are described below and shown in the figures provided below.

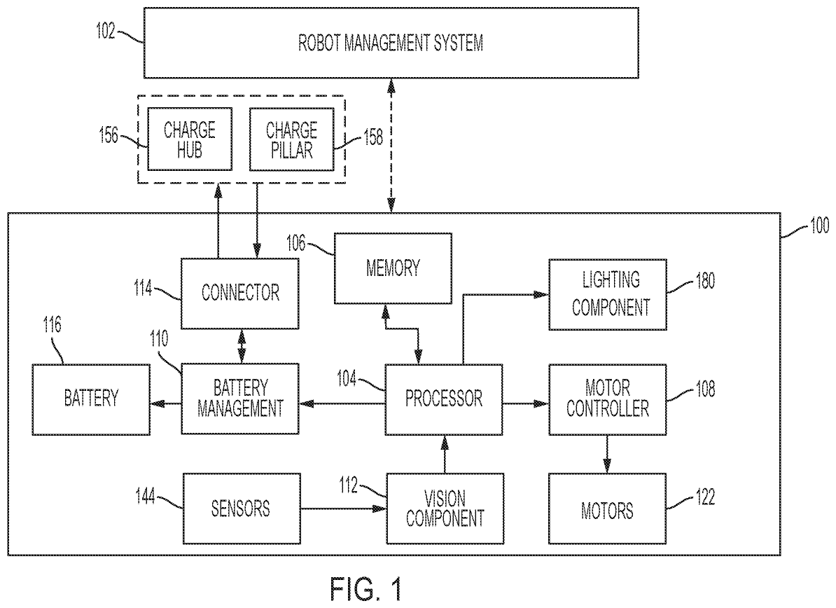

FIG. 1 illustrates a block diagram of a non-limiting example of a system 100, according to some embodiments.

A system 100, which may also be referred to as autonomous charging robots and/or robot operating system (ROS) 100, includes one or more modules and/or components corresponding to an autonomous charging robot capable of delivery of a high capacity energy storage system (e.g., batteries) between locations to charge the energy storage system from an electrical power source and to discharge the energy storage system to an external energy storage system such as, for example, in an EV. The system 100 may be in electrically communicable connection with a robot management system 102 that directs deployment of one or more autonomous charging robots such as, for example, system 100 between one or more charging hubs 156, also referred to as hub posts, connected to a power grid or power generator and one or more charging posts configured to connect to EVs.

As illustrated, the system 100 communicates with the robot management system 102 via a network connection. In many embodiments, the system 100 may communicate using a wireless communication system (e.g., Cellular connection, Wireless Local Area Network (WI-LAN), Bluetooth, or any other wireless communication protocol that might be apparent to a person of ordinary skill in the art). However, example embodiments are not limited to this configuration and may communicate with the robot management system using a wired connection or any other connection that might be apparent to a person of ordinary skill in the art.

The system 100 includes a processor 104, a memory 106, a motor controller 108, a battery management component 110, a vision component 112, and a connector 114. The processor 104 provides one or more control functionalities including battery management, 360° vision processing through vision component 112, lighting control component 180 to improve visibility, and motor control. In some embodiments, the system 100 may include one or more processors, such as processor 104 for performing the one or more control functionalities as described herein. The memory 106 may include a non-transitory computer readable medium having stored thereon instructions that are executable by the processor to perform operations including the one or more control functionalities. The instructions stored in the processor 104 may be executed by the processor to control the operation of the one or more other modules of the system 100, as will be further described herein. In some embodiments, the system 100 may include a computing device including the processor 104 and memory 106 and robot management system 102. The computing device may include other components from the one or more other modules such as, for example, the motor controller 108.

The system 100 includes the motor controller 108. The motor controller 108 may be configured to control operation of one or more motors 172 coupled to locomotion systems to move the system 100. In this regard, in some embodiments, the motor controller 108 may further include a processor and a memory having stored thereon instructions that are executable by the processor to perform operations including controlling the operation of the one or more motors to move the system 100, as will be further described herein.

The system 100 includes the battery management component 110. The system 100 also includes a battery 116, the battery management component 110 being configured to control the charge/discharge operations of the battery 116. The battery 116 may be a high capacity energy storage device including therein one or more battery packs coupled together, according to some embodiments. Each battery pack may include therein one or more battery cells coupled together. The number of battery cells in each battery pack and the number of battery packs in the battery 116 and included in the system 100 may be configured depending on the charging requirements of a particular charging facility.

The system 100 may include the vision component 112. The vision component 112 may include a 360° machine vision system configured to detect and/or identify objects in a vicinity of the system 100 based on inputs from one or more sensors 144. The vision component 112 may obtain the input data from the one or more sensors 144 and may apply one or more models and/or techniques to the input data such as, for example, computer vision models to identify different objects in the images. This enable the system 100 to map a course to navigate between the charging hub 156 and the charging post to perform the charging operations as described herein, to determine the mapped course is impeded by an object, map a detour between its present location and the charging hub 156 or the charging post, and to identify a location of a complementary connection interface on the charging hub 156 or the charging pillar 158 to enable a docking port 168 on the system 100 to connect the charging hub 156 or charging pillar 158. In some embodiments, the one or more sensors 144 may emit light pulses and detect objects in an area surrounding the system 100 based on the emitted light pulses that are detected as being reflected back to the one or more sensors 144. In other embodiments, the one or more sensors 144 may include one or more cameras configured to capture one or more images of scenes which when compiled show a scene of the 360° area surrounding the system 100. It is to be appreciated by those having ordinary skill in the art that the one or more sensors 144 of the system 100 are not intended to be limiting and may include any of a plurality of different types of sensors capable of monitoring various different parameters including, but not limited to, location, position, orientation, object proximity, collision detection, noise, temperature, humidity, battery charge level, voltage, current, other parameters, or any combinations thereof.

The system 100 includes the connector 114. The connector 114 enables the system 100 to selectively couple to either a charging post or a hub post to send or receive energy. The connector 114 includes therein one or more components capable of a mating physical engagement to a connection interface at the charging post or the hub post having therein one or more complementary components configured to enable the connector 114 to connect to the charging post or the hub post.

The system 100 and the components of the system 100 are discussed in greater detail below.

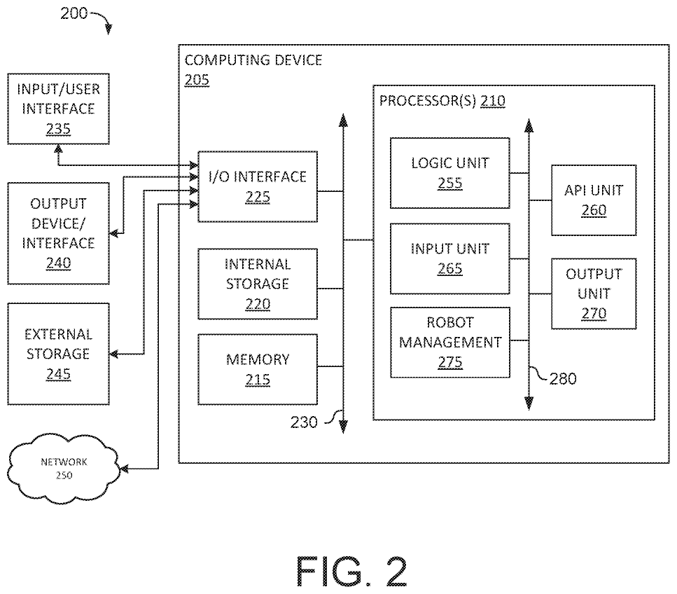

FIG. 2 illustrates a block diagram of a non-limiting example computing environment 200 of the system 100, according to some embodiments.

Computing device 205 in computing environment 200 can include one or more processing units, cores, or processors 210, memory 215 (e.g., RAM, ROM, and/or the like), internal storage 220 (e.g., magnetic, optical, solid state storage, and/or organic), and/or I/O interface 225, any of which can be coupled on a communication mechanism or bus 230 for communicating information or embedded in the computing device 205. Computing device 205 can be communicatively coupled to input/interface 235 and output device/interface 240. Either one or both of input/interface 235 and output device/interface 240 can be a wired or wireless interface and can be detachable. Input/interface 235 may include any device, component, sensor, or interface, physical or virtual, which can be used to provide input (e.g., buttons, touch-screen interface, keyboard, a pointing/cursor control, microphone, camera, braille, motion sensor, optical reader, and/or the like).

Output device/interface 240 may include a display, television, monitor, printer, speaker, braille, or the like. In some embodiments, input/interface 235 (e.g., user interface) and output device/interface 240 can be embedded with, or physically coupled to, the computing device 205. In other embodiments, other computing devices may function as, or provide the functions of, an input/interface 235 and output device/interface 240 for a computing device 205. These elements may include, but are not limited to, well-known AR hardware inputs so as to permit a user to interact with an AR environment.

Computing device 205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, server devices, other computers, information kiosks, televisions with one or more processors embedded therein and/or coupled thereto, radios, and the like).

Computing device 205 can be communicatively coupled (e.g., via I/O interface 225) to external storage 245 and network 250 for communicating with any number of networked components, devices, and systems, including one or more computing devices of the same or different configuration. Computing device 205 or any connected computing device can be functioning as, providing services of, or referred to as a server, client, thin server, general machine, special-purpose machine, or another label.

I/O interface 225 can include, but is not limited to, wired and/or wireless interfaces using any communication or I/O protocols or standards (e.g., Ethernet, 802.1 lxs, Universal System Bus, WiMAX, modem, a cellular network protocol, and the like) for communicating information to and/or from at least all the connected components, devices, and network in computing environment 200. Network 250 can be any network or combination of networks (e.g., the Internet, local area network, wide area network, a telephonic network, a cellular network, satellite network, and the like).

Computing device 205 can use and/or communicate using computer-usable or computer-readable media, including transitory media and non-transitory media. Transitory media includes transmission media (e.g., metal cables, fiber optics), signals, carrier waves, and the like. Non-transitory media includes magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 210 can execute under any operating system (OS) (not shown), in a native or virtual environment. One or more applications can be deployed that include logic unit 255, application programming interface (API) unit 260, input unit 265, output unit 270, robot management unit 275, and inter-unit communication mechanism 280 (e.g., a data bus) for the different units to communicate with each other, with the OS, and with other applications (not shown). For example, output unit 270, robot management unit 275, and inter-unit communication mechanism 280 may implement one or more processes to communicate and control the robots of the system. The described units and elements can be varied in design, function, configuration, or implementation and are not limited to the descriptions provided.

In some embodiments, when information or an execution instruction is received by API unit 260, it may be communicated to one or more other units (e.g., robot management unit 275). For example, the robot management unit 275 may determine how the robot should be controlled and communicate the instructions through the output unit 270. In some instances, the logic unit 255 may be configured to control the information flow among the units and direct the services provided by API unit 260, robot management unit 275, and inter-unit communication mechanism 280 in some example embodiments as described above. For example, the flow of one or more processes or implementations may be controlled by logic unit 255 alone or in conjunction with API unit 260.

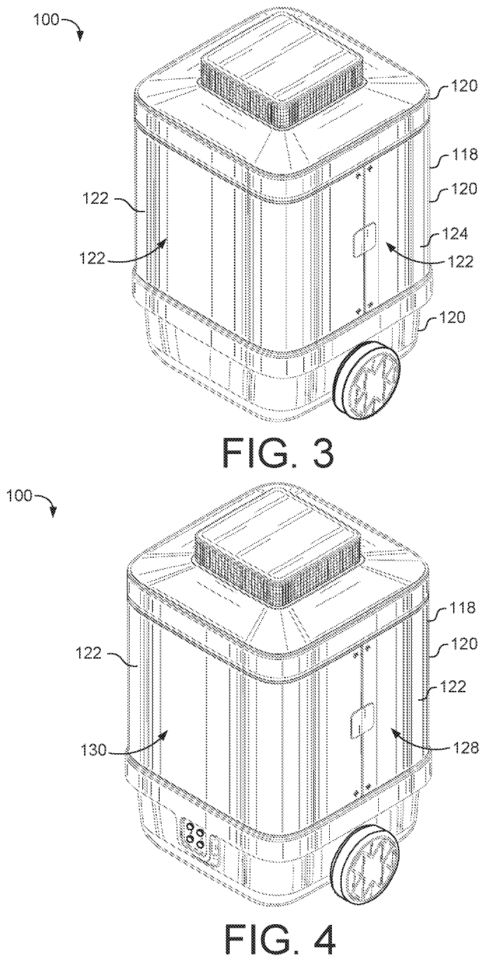

FIG. 3 illustrates a first perspective view of the system 100, according to some embodiments. FIG. 4 illustrates a second perspective view of the system 100, according to some embodiments. Unless specifically referenced, FIGS. 3 and 4 will be described collectively.

The system 100 may include any of a variety of form factors in accordance with the present disclosure. In a non-limiting example embodiment, the system 100 may include dimensions of approximately 600 mm (L)×600 mm (W)×900 mm (H). However, it is to be appreciated by those having ordinary skill in the art that the system 100 may have a variety of form factors (e.g., size, shape, and dimensions) and is not intended to be limited to the forms as may be described in the present disclosure and/or as illustrated as example embodiments in the figures.

The system 100 includes a body 118. The body 118 may define locations for one or more modules of the system 100, as will be further described herein. The system 100 also includes a housing 120 arranged on the body 118 and defining an exterior dimension of the system 100.

The body 118 and/or the housing 120 of the system 100 may define one or more sides 122. In some embodiments, the system 100 may include a first side 124 corresponding to a front of the system 100, a second side 126 corresponding to a right side of the system 100 relative to the first side 124 as shown in FIG. 3, a third side 128 opposite the second side 126 and corresponding to a left side of the system 100 relative to the first side 124 as shown in FIG. 3, and a fourth side 130 opposite the first side 124 and corresponding to a rear of the system 100 relative to the first side 124 as shown in FIG. 4. In other embodiments, the system 100 may include a single side that circumferentially extends around the system 100 and the one or more modules arranged therein. For example, the housing 120 may include a single sidewall that substantially surrounds the exterior of the system 100 such that the system 100 is substantially cylindrical in shape.

The housing 120 may include a single unitary member that substantially surrounds the body 118 and the one or more modules of the system 100. In other embodiments, the housing 120 may include one or more members, each member configured to be arranged on the body 118 such as to substantially surround the body 118 and the one or more modules.

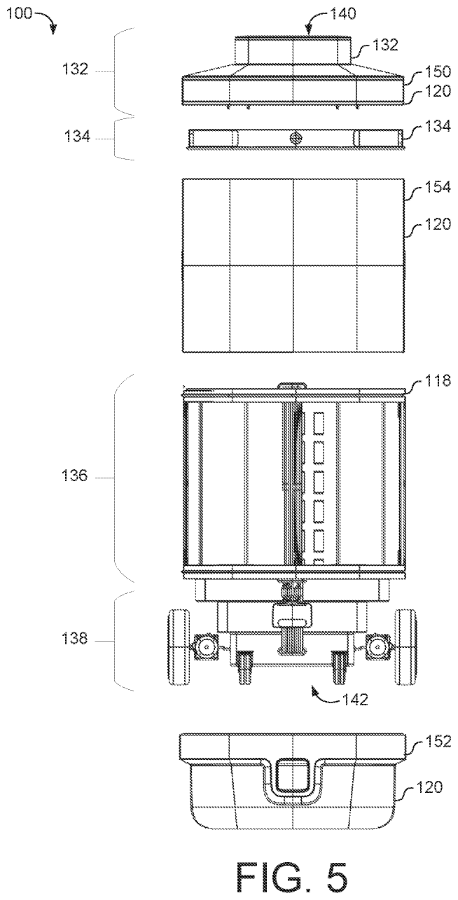

FIG. 5 illustrates a partially exploded view of the system 100, according to some embodiments.

The system 100 may include a control module 132, a vision module 134, a battery module 136, and a drive module 138. The control module 132 and vision module 134 may define an autonomous stack corresponding to the “brains” of the system 100 where control of the one or more other modules stems from to enable the system 100 to perform the charging operations as will be further described herein. The control module 132 and the vision module 134 may be located under the housing 120 at a first end 140 of the system 100.

The control module 132 includes the processor 104 and the memory 106. In some embodiments, the control module 132 may include the vision component 112. In other embodiments, the control module 132 may further include the motor controller 108, the battery management component 110, or both. The control module 132 may be configured to be in electrically communicable connection with each of the one or more components and/or the one or more other modules of system 100 to perform the charging operations in accordance with the present disclosure.

The system 100 includes the vision module 134 located adjacent the first end 140 between the control module 132 and the battery module 136. The vision module 134 includes one or more sensors 144. The one or more sensors 144 may include any of a plurality of different types of sensors for monitoring one or more characteristics or parameters associated with the system 100. The vision module 134 may be in electrically communicable connection with the control module 132 and may send the characteristics or parameters from the one or more sensors 144 to the control module 132 to enable the system 100 to perform the operations as described herein.

The one or more sensors 144 may include one or more different types of sensor devices for monitoring different characteristics or parameters associated with the system 100. The one or more sensors 144 may include cameras, gyroscopic sensors, global positioning system (“GPS”) sensors, velocity sensors, microphones, temperature gauges, current and voltage sensors, hygrometers, other sensor types, or any combinations thereof. The one or more sensors 144 may measure/monitor one or more characteristics and/or parameters associated with the system 100 including, but not limited to, location, position, orientation, other object proximity, collision detection, noise, temperature, humidity, battery charge level, voltage, current, other characteristics and/or parameters, or any combinations thereof.

The one or more sensors 144 of the vision module 134 may include one or more cameras for continuously capturing images of a scene surrounding the system 100 while the system 100 is moving or is preparing to move, according to some embodiments. For example, the system 100 may include a camera arranged on each side approximately 90° apart, each camera may capture video including one or more images of a respective scene surrounding the system 100. In some embodiments, the vision module 134 may send the images to the control module 132, and the control module 132 may obtain the images and apply the one or more computer vision models and/or techniques to the images to identify objects in a 360° area surrounding the system 100 based on the images. In other embodiments, the vision module 134 may include therein a processor and memory having stored thereon instructions including the one or more computer vision models and/or techniques and may analyze the images to identify objects in the 360° area surrounding the system 100 based on the images and may send the data to the control module 132.

The system 100 includes the battery module 136 located between the vision module 134 and the drive module 138. The body 118 of the system 100 substantially comprises the battery module 136. The battery module 136 includes a battery 116, which may be a high capacity energy storage device including therein one or more battery packs electrically connected with the other battery packs in the battery 116, according to some embodiments. Each battery pack may include one or more battery cells electrically connected together. The number of battery cells in each battery pack and the number of battery packs in the battery 116, and in the system 100, may be configured based on any of a plurality of factors. For example, the capacity of the battery 116 may be based on the total dimensions of the system 100. In another example, the capacity of the battery 116 may depend on the charging requirements of a particular charging facility.

The system 100 includes the drive module 138 located at a second end 142 of the system 100. The drive module 138 is configured to move the system 100 between different locations such as, for example, between the charging hub 156 and the charging post. The drive module 138 includes a plurality of wheels configured to provide a motive force to enable the system 100 to move in a certain directions, to turn, and/or to rotate in place.

Each of the control module 132, vision module 134, battery module 136, and/or the drive module 138 may be connected to the other modules of the system 100 by a bus 146. The bus 146 may include one or more electrical conductors to enable the one or more components to be in electrical communicable connection. The bus 146 may extend between and connect to the control module 132 at the first end 140 and the drive module 138 at the second end 142 and may also connect to each of the other modules therebetween. In some embodiments, the connector 114 may also be connected to the bus 146. In this regard, the bus 146 may include one or more electrical conductors to enable the battery 116 in the battery module 136 to be placed in electrical connection with the connector 114 to perform the charge/discharge operations as described herein.

The housing 120 of the system 100 may include one or more members. In some embodiments, the housing 120 may include a first housing member 150 at the first end 140, a second housing member 152 at the second end 142, and a third housing member 154 arranged between the first housing member 150 and second housing member 152. The first housing member 150 may be configured to substantially surround the control module 132 and/or the vision module 134, the second housing member 152 may be configured to substantially surround the drive module 138, and the third housing member 154 may be configured to substantially surround the battery module 136.

The housing 120 may be made of one or more different types of materials having adequate rigidity and durability to enable the system 100 to perform the operations as described herein and to sufficiently withstand deformation which may result from normal wear and tear, scratches, damage, objects colliding with the system 100, and other like causes. In some embodiments, the housing 120 may be made of materials including, but not limited to, Aluminum, stainless steel, thermoplastics, carbon fiber, other metals, other polymers, or any combinations thereof.

The first housing member 150, the second housing member 152, and/or the third housing member 154 may be formed of molded thermoplastics that substantially covers respective inner portions of the system 100, according to some embodiments. In other embodiments, the first housing member 150 and the second housing member 152 may be formed of molded thermoplastics and the third housing member 154 may be made substantially of stainless steel. The housing 120 may include stainless-steel panels that are removably attached and able to access the interior components when removed, according to some embodiments. For example, in some embodiments, the third housing member 154 may be formed from one or more stainless-steel panels that may be removably attached from the body 118 of the system 100 to provide access to the interior components of the system 100. However, example embodiments are not limited to stainless steel, and other rigid, durable materials may be used in forming the external panels of the housing 120. As a person having ordinary skill in the art may recognize to avoid weight concerns, panel material may be selected by balancing the density against the durability.

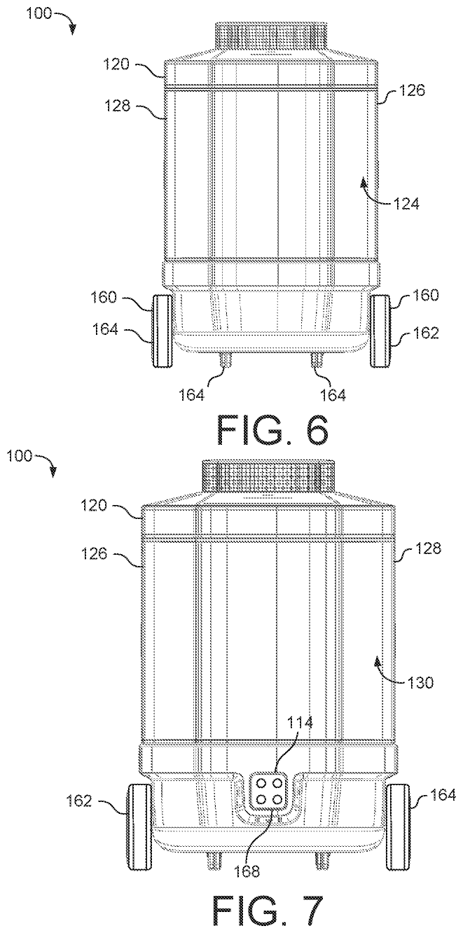

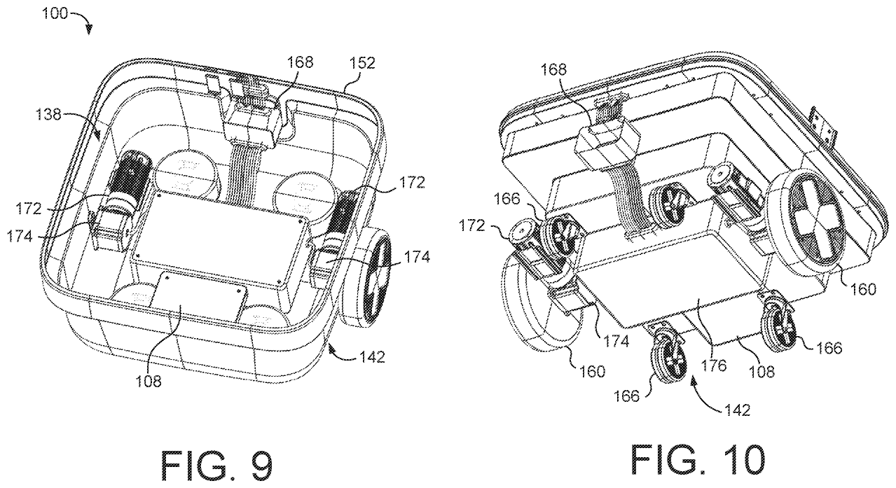

FIG. 6 illustrates a front view of the system 100, according to some embodiments. The system 100 includes two centrally and independently driven wheels 160 arranged on opposite sides of the system 100 and defining a drive axis. Each drive wheel 160 may be connected to a motor 172 (FIG. 9), which provides a motive force to the respective drive wheel 160 to enable the system 100 to move in one or more directions between various locations. In some embodiments, the system 100 may include a first drive wheel 162 located at the second side 126 and a second drive wheel 164 located at the third side 128. In other embodiments, the first drive wheel 162 may be located at the first side 124 and the second drive wheel 164 may be located at the fourth side 130 of the system 100. The system 100 may also include one or more caster wheels 166, which enables the system 100 to change direction and to turn with a minimum or reduced turning envelope, as will be further described herein.

FIG. 7 illustrates a rear view of the system 100, according to some embodiments. The system 100 includes the connector 114 arranged on one of the sides 122. In some embodiments, the connector 114 may be arranged on the fourth side 130. The connector 114 may include a docking port 168, the docking port 168 defining an opening configured to receive a connection interface of the charging hub 156 or the charging post therein to enable the connector 114 and the system 100 to be placed in mating electrical connection with the charging hub 156 or the charging post to either charge the battery 116 from the power source or discharge the battery 116 to charge the energy storage system of the EV.

According to some embodiments, the connector 114 and the docking port 168 directly connect to the charging hub 156 to charge the battery 116 and the charging pillar 158 to charge the EV battery. In some embodiments, the robot management system 102 and the connector 114 and the docking port 168 do not directly connect to the EV and/or the EV battery. Instead, to charge the EV battery, the robot management system 102 connects to the charging pillar 158 and the charging pillar 158 connects to the EV to charge the EV battery with the electrical energy stored in the battery 116.

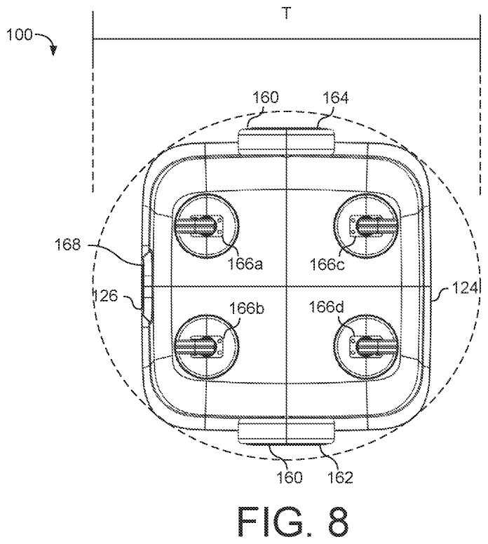

FIG. 8 illustrates a bottom view of the system 100, according to some embodiments. The system 100 includes the two centrally and independently driven wheels 160 and one or more caster wheels 166. The two centrally and independently driven wheels 160 allow the system 100 to move in a forward direction, a rearward direction, or both. The one or more caster wheels 166 provide support to the system 100 and allow the system 100 to turn within a certain turning envelope T, which may be a reduced turning envelope as compared to if the system 100 did not include the one or more caster wheels 166. As such, the turning envelope of the system 100 may vary depending on the number of caster wheels 166 installed onto the device. For example, in some embodiments, the system 100 may include four caster wheels 166 that enable the system 100 to have a 700 mm spot turning envelope.

In some embodiments, the one or more caster wheels 166 may include a first caster wheel 166a, a second caster wheel 166b, a third caster wheel 166c, and a fourth caster wheel 166d, which hereinafter may also be referred to as caster wheels 166. The caster wheels 166 may be arranged such that each of the caster wheels 166 are equidistant from each other along a bottom surface of the system 100, according to some embodiments. In other embodiments, the one or more caster wheels 166 may be arranged along the bottom surface of the system 100 to allow an even distribution of the weight of the system 100 (e.g., the battery module 136) while allowing the system 100 to maintain as narrow a turning envelope as possible. In some embodiments, the battery module 136 may include a first pair of caster wheels 166a, 166b located on one side of a drive axis defined by the drive wheels 160 and a second pair of caster wheels 166c, 166d located on an opposite side of the drive axis relative to the first pair of caster wheels 166a, 166b.

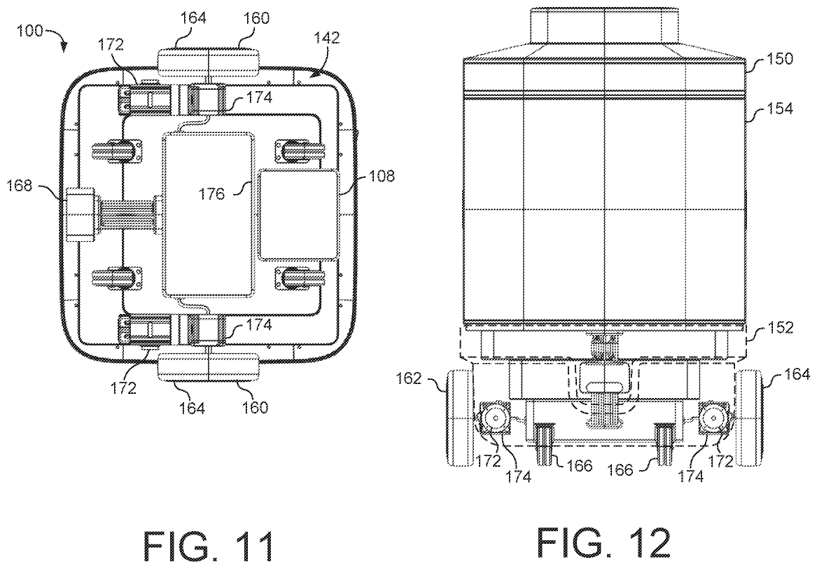

FIG. 9 illustrates a top perspective view of a portion of the system 100, according to some embodiments. FIG. 10 illustrates a bottom perspective view of the portion of the system 100, according to some embodiments. FIG. 11 illustrates a bottom view of the portion of the system 100, according to some embodiments. FIG. 12 illustrates an exposed side view of the portion of the system 100, according to some embodiments. Unless specifically referenced, FIGS. 9-12 will be described collectively.

The drive module 138 may be covered by the second housing member 152 which forms a molded bumper over one or more components of the drive module 138. The drive module 138 may include a motor controller 108, one or more drive wheels 160, one or more caster wheels 166, one or more motors 172, and one or more gear boxes 174. The motor controller 108 includes therein one or more electrical components configured to electrically communicate with the control module 132 and control an operation of the components of the drive module 138. In some embodiments, the motor controller 108 may include a processor(s) and a memory. The memory may include a non-transitory computer readable medium having stored thereon instructions executable by the processor(s) to enable the motor controller 108 to perform operations including controlling the operation of the one or more motors 172 to enable the system 100 to move between locations and to enable the system 100 to connect to the charging hub 156 or the charging post. In some embodiments, the motor controller 108 may be in electrically communicable connection with the control module 132 and the motor controller 108 may obtain commands from the control module 132 and control the operation of the one or more motors 172 to move the system 100 based on the commands.

The motor controller 108 may be arranged in the drive module 138 between the two centrally and independently driven wheels 160 and between the motors 172. In some embodiments, the motor controller 108 may also be arranged between two of the caster wheels 166 adjacent the first side 124. In other embodiments, the motor controller 108 may be arranged between two of the caster wheels 166 adjacent the fourth side 130. In some embodiments, the motor controller 108 may include a first motor controller to control the operation of the first motor 172 and may include a second motor controller to control the operation of the second motor 172 based on commands obtained from the control module 132.

Each of the drive wheels 160 may be coupled to a motor 172 and a gear box 174 opposite the second housing member 152 at the system 100 exterior, with caster wheels 166 located in front of and behind the drive axis defined by the drive wheels 160 and their axis of rotation. The drive wheels 160 may include one or more members that extend through openings defined in the housing 120 and connect to the respective motor 172 and/or gear box 174. In some embodiments, the drive wheels 160 may be connected to a drive rod that connects the drive wheel 160 to the gear box 174 and/or the motor 172 to enable the motor 172 to cause the drive wheel 160 to rotate in the forward or reverse direction.

The drive module 138 includes the one or more caster wheels 166 located at the exterior bottom surface of the system 100. In some embodiments, the drive module 138 may include four caster wheels 166, with two caster wheels 166 arranged on each side of the drive axis. In other embodiments, the drive module 138 may include three caster wheels 166, with two caster wheels 166 arranged on one side of the drive axis (e.g., adjacent the fourth side 130) and one caster wheel 166 arranged on the opposite side of the drive axis (e.g., adjacent the first side 124). In yet other embodiments, the drive module 138 may include one caster wheel 166 arranged on one side of the drive axis and another caster wheel 166 arranged on the opposite side of the drive axis.

Each of the caster wheels 166 may attach to the bottom of the system 100 using one or more fasteners. In some embodiments, the one or more caster wheels 166 may include a plate member defining one or more holes configured to receive a fastener extending therethrough to attach the caster wheel 166 to the bottom of the second housing member 152. In some embodiments, the second housing member 152 may include one or more locations defined by an embossment for each of the caster wheels 166 to be positioned. Additionally, each embossment may further define one or more openings configured to receive the fasteners extending therethrough to enable the caster wheel 166 to be coupled to the second housing member 152 and/or the system 100.

The fasteners may include any of a plurality of types of fasteners including, but not limited to, screws, bolts, nuts, rivets, clamps, clips, epoxies, adhesives, other types of fasteners, or any combinations thereof. It is also to be appreciated that the drive wheels 160 and the caster wheels 166 are not intended to be limiting and the system 100 may include any of a plurality of other components to enable the drive wheels 160 and/or the caster wheels 166 to be installed onto the system 100 such that the system 100 may move between different locations and may turn with a minimal spot turning envelope.

In some embodiments, the drive module 138 may include a drive battery module 176. The drive battery module 176 may be a separate battery module including therein one or more batteries having one or more battery packs that may power the motors 172 as well as provide power to the motor controller 108 and the PCBs for the control module 132 and other control systems. This allows the drive module 138 to navigate the system 100 back to the hub charging pillars 158 even if the battery module 136 is fully depleted. Both the battery 116 and the drive battery module 176 may be charged via the connector 114 described above.

Additionally, the control module 132 may include a docking port 168, which includes therein the connector 114 to enable the system 100 to dock with and connect to both the charging hub 156 that provides energy to the battery 116 in the system 100 and/or the drive battery module 176 and the EV charging pillars 158 that can couple to EVs and receive energy from the battery 116.

It is to be appreciated by those having ordinary skill in the art that the drive module 138 as described herein and as shown in the figures is an example embodiment of a locomotion system and is not intended to be limiting. Thus, the system 100 and the drive module 138 may include one or more of the components described herein and/or may include other component(s) configured to enable the system 100 to move between locations and to connect to the charging hub 156 and the charging pillar 158. For example, the system 100 may include one or more components to enable the system 100 to move along a system of tracks connecting the one or more charging hubs 156 to each of the one or more charging pillars 158 in a charging facility such that the processing demand for mapping a course between the one or more charging hubs 156 and the one or more charging pillars 158 may be reduced.

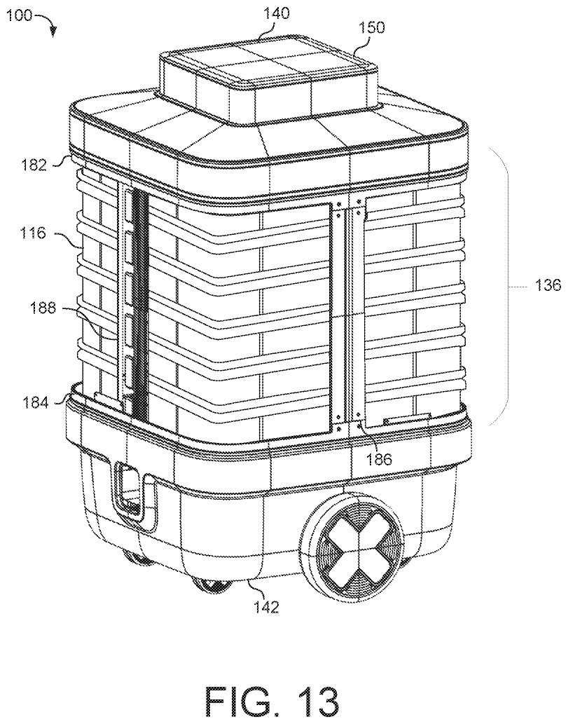

FIG. 13 illustrates an exposed perspective view of the system 100, according to some embodiments.

With the third housing member 154 removed, the body 118 of the system 100 is revealed along with the battery module 136 and battery 116. The body 118 may be defined by a chassis that is positioned to sit on the drive module 138 and underneath the control module 132 and vision module 134. The body 118 chassis may include a first frame member 182 located adjacent the first end 140 (and vision module 134) and a second frame member 184 located adjacent the second end 142 (and drive module 138) opposite the first frame member 182. The first frame member 182 may be connected to the second frame member 184 by one or more braces 186 that extend therebetween, such that the battery 116 is positioned between the first frame member 182, the second frame member 184 and the one or more braces 186 to seal the battery 116 therebetween and to help secure the battery 116 in the system 100. In some embodiments, the first frame member 182, second frame member 184, and one or more braces 186 may be formed from aluminum. However, it is to be appreciated by those having ordinary skill in the art that these materials are not limited to aluminum and other rigid, durable materials may be used. As a person of ordinary skill in the art may recognize to avoid weight concerns, chassis material may be selected by balancing the density against the durability.

In order to provide weather sealing between the chassis frame members and the exterior panels of the housing 120 (e.g., the stainless-steel panels), an elastic or elastomeric gasket (not shown) may be provided, in some example embodiments. In some embodiments, venting openings may be provided in the housing 120 to facilitate maintenance and regulation of optimal internal temperatures during charging and discharging of the internal batteries (e.g., both the EV charging battery module and the auxiliary drive battery module).

As illustrated in FIG. 13, the battery module 136 includes a wiring harness 188. The wiring harness 188 includes one or more electrical conductors that extend downward from the autonomous stack of the vision module 134 and/or the control module 132 and bridging all of the electrical components of each of the modules 132, 134, 136, 138. Additionally, the wiring harness 188 may be connected to docking port 168 to enable the battery 116 to connect to the charging hub 156 or the charging pillar 158 to either charge the battery 116 or for the battery 116 to charge the EV battery.

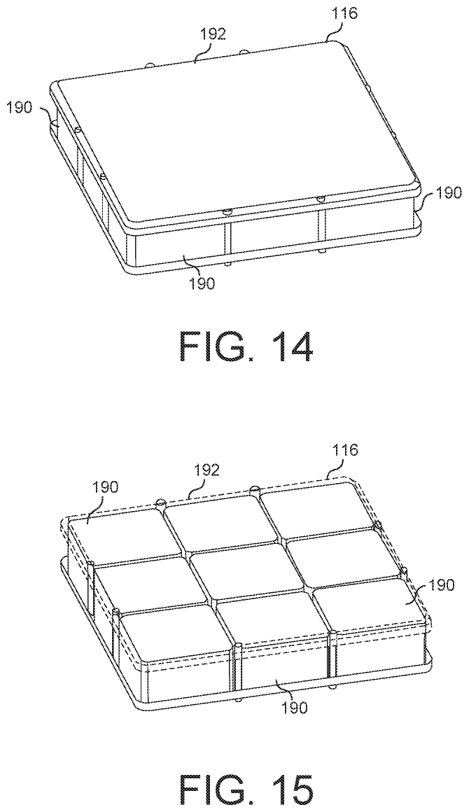

FIG. 14 illustrates a perspective view of a portion of the system 100, according to some embodiments. FIG. 15 illustrates an exposed perspective view of the portion of the system 100, according to some embodiments. Unless specifically referenced, FIGS. 14 and 15 will be described collectively.

The system 100 includes therein the battery 116. The battery 116 may include one or more power packs 190 forming layers in electrical connection with other power pack layers of the battery 116. Each power pack 190 may also include one or more modules 192 in electrical connection with the other modules in the respective power pack 190.

For each layer of the power pack 190, the modules 192 are arranged in various configurations that may then be stacked together to form the battery 116.

The number of modules 192 in each power pack 190 may depend on various conditions such as, for example, the dimensions of the battery module 136, the dimensions of the system 100, the charging requirements of the system 100 and/or the charging facility, or other like factors. In this regard, FIG. 15 shows a power pack 190 layer. The modules 192 in each power pack 190 may have a generally rectangular housing enclosing a plurality of individual cells. Each module 192 may holds 36 individual cells having a generally cylindrical shape and arranged in a 6×6 matrix, according to some embodiments. In some embodiments, the cells may be lithium ion cells. For example, in some embodiments, rechargeable 18650 lithium ion cells may be used in the modules 192. In another example embodiment, rechargeable 21700 lithium ion cells may be used in the modules 192.

The battery 116 may include one or more larger power packs 190 formed from 16 individual modules arranged in a 4×4 matrix, according to some embodiments. In some embodiments, and as shown in FIG. 15, the battery 116 may include one or more smaller power pack 190 layers formed from 9 individual modules arranged in a 3×3 matrix. In the power pack 190, the individual modules 192 are sandwiched between a pair of support plates held together by bracket pillars arranged on all four sides. This configuration can provide support for the modules while also allowing air circulation to provide cooling of the modules and improved temperature regulation.

However, it is to be appreciated by those having ordinary skill in the art that the battery 116 including the individual power pack 190 layers and the modules 192, are not intended to be limiting and the battery 116 may include more or less power packs 190 of any of a plurality of different sizes based on any of a plurality of factors in accordance with the present disclosure. For example, in some embodiments, the battery module 136 may include therein a battery 116 made up of a stack of 8 power pack layers, with 7 power packs being configured as large power packs stacked on top of one power pack being configured as the smaller power pack that is nestled into a space in the lower portion of the chassis described above. This configuration produces a total EV charging battery module having 121 battery modules formed from 4356 individual rechargeable batteries collectively providing 41678 Kw/h of storage, and which produces a battery mass of approximately 200 kg. By constructing the EV charging battery module with stacks of battery packs of different sizes as shown, the design and layout can be customized to different form factors as may be recognized by a person of ordinary skill in the art. The individual battery packs may be held together by vertical braces and may be connected to the chassis by mounting brackets.

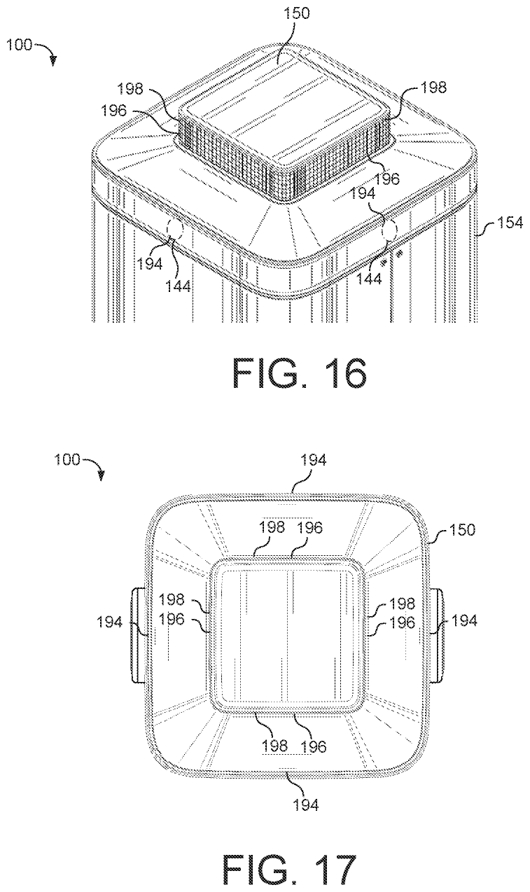

FIG. 16 illustrates a perspective view of a top portion of the system 100, according to some embodiments. FIG. 17 illustrates a top view of the system 100, according to some embodiments. Unless specifically referenced, FIGS. 16 and 17 will be described collectively.

At the first end 140 and beneath the first housing member 150, the autonomous stack of the system 100 includes therein the control module 132 and the vision module 134. The control module 132 may include one or more printed circuit boards (“PCBs”), which may be located on top of the PCBs of the vision module 134 in the first housing member 150, in some embodiments. The vision module 134 provides the system 100 and the control module 132 with 360° vision capability provided by the one or more sensors 144. In some embodiments, the vision module 134 may include wide-angle imaging sensors provided on each side 122 of the system 100. In example implementations, the vision module 134 may also include LIDAR systems.

Referring to FIG. 16, the first housing member 150 may be made of molded thermoplastic, according to some embodiments. The first housing member 150 may also include one or more viewing ports 194 of tinted molding located on one or more sides, according to some embodiments. The viewing ports 194 may be transparent or semi-transparent to enable the one or more sensors 144 to capture images of a scene of the area surrounding the system 100. The sensors 144 may be arranged at a respective one of the viewing ports 194 of the first housing member 150 such that each sensor 144 may be capable of capturing images of a respective scene surrounding the system 100 while the first housing member 150 protects the vision module 134 and control module 132 from dirt, debris, weather, external interference, and other factors which may potentially cause damage to the components located in the first housing member 150 and the rest of the system 100.

Referring again to FIG. 16, the system 100 includes an LED matrix 196 located in the first housing member 150 adjacent the first end 140. The LED matrix 196 may selectively illuminate one or more LED pixels on a display of the LED matrix 196 to signal one or more different states of the system 100. In some embodiments, the control module 132 may control an operation of the LED matrix 196 including sending a signal to the LED matrix 196 corresponding to a states of one or more different states and the LED matrix 196 selectively illuminating the one or more LED pixels on the display based on the signal from the control module 132. As such, each of the states may be associated with a unique LED matrix configuration displayed on the display of the LED matrix 196. The different states that may be signaled by the LED matrix 196 include, but are not limited to, a wake-up state, a moving state, a looking state, a turning state, a charging state, and a low battery state.

Additionally, the first housing member 150 may include one or more viewing ports 198 for the LED matrix 196. The one or more viewing ports 198 may be tinted molded sections similar to viewing ports 194 for the sensors 144 of the vision module 134 but having a cross-sectional area that may accommodate the size of the LED matrix 196. The LED matrix 196 may be installed at the one or more viewing ports 198 such that the LED matrix 196 may be viewable from the exterior of the system 100 such as, for example, by pedestrians in an area of the system 100 and the charging facility.

The system 100 may include one or more LED matrix 196 located on one or more sides of the system 100 and viewable through the one or more one or more viewing ports 198. In some embodiments, the system 100 may include one LED matrix 196 located on the first side 124. In other embodiments, the system 100 may include a first LED matrix 196 located on the first side 124 and a second LED matrix 196 located on the fourth side 130. In yet other embodiments, the system 100 may include a LED matrix 196 at each side of the system 100. In some embodiments, a top portion of the first housing member 150 may include four sides and each of the sides may include a LED matrix 196 viewable through a respective viewing ports 198.

In a non-limiting example, the LED matrix 196 may: under the wake-up state, nothing may be displayed over the LED matrix 196; under the moving state, the leftmost section of the LED matrix 196 may be lit to indicate the moving state of the system 100; under the looking state, an adjacent section to the leftmost section of the LED matrix 196 may be lit to indicate the looking state of the system 100; under the turning state, the LED matrix 196 may be lit in the mid-section in the vertical direction to indicate the turning state of the system 100; under the charging state, the entire LED matrix 196 may be lit to indicate the charging state of the system 100; and under the low battery state, the entire LED matrix 196 may be lit with the left and right edges of the LED matrix 196 slightly dimmed to indicate the low battery state of the system 100.

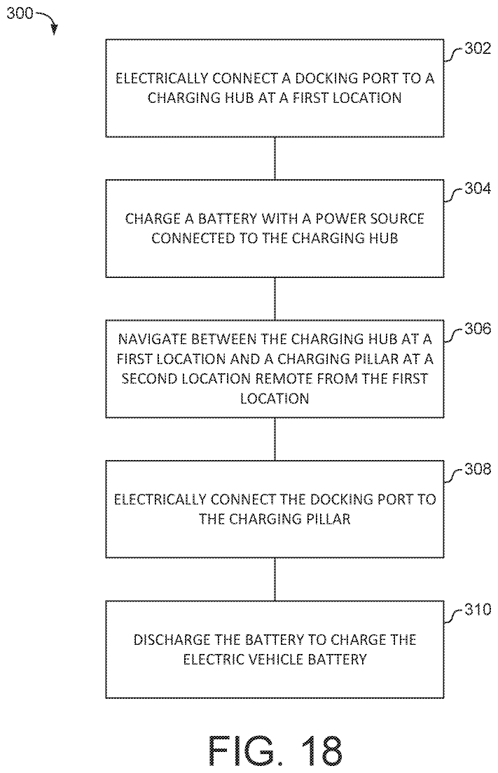

FIG. 18 illustrates a flow diagram of a method 300, according to some embodiments.

At 302, the method 300 includes electrically connecting the docking port 168 to a charging hub 156 at a first location. The docking port 168 may define a receptacle and may include therein connector 114 to electrically connect to the charging hub 156 or a charging pillar 158.

At 304, the method 300 includes charging the battery with the charging hub 156. The docking port 168 and the connector 114 is electrically connected to the battery module 136, the battery module 136 including a battery 116 for storing electrical power to charge an electric vehicle battery. In some embodiments, the docking port 168 and connector 114 may be connected to the vision module 134 and battery 116 through a wiring harness 188. Additionally, in some embodiments, the wiring harness 188 may also connect to one or more other modules of the system 100 including, but not limited to, control module 132, vision module 134, and drive module 138.

At 306, the method 300 includes navigating and moving between the charging hub 156 at the first location and a charging pillar 158 at a second location remote from the first location. In some embodiments, the control module 132 may control the one or more other modules to move the system 100 between different locations including the charging hub 156 and the charging pillar 158. In some embodiments, the vision module 134 may include one or more sensors for detecting objects in proximity to the one or more sensors (and the system 100), and the vision module 134 may analyze the signals to identify objects in an area surrounding the system 100. In some embodiments, the control module 132 may obtain electrical signal data from the one or more sensors and identify one or more objects in the area surrounding the system 100 based on the electrical signal data.

In some embodiments, the method 300 may include obtaining, from a charging pillar 158, a request to deliver a charged battery module 136 to the charging pillar 158 at the second location. In other embodiments, the method 300 may include obtaining, from a computing device associated with the charging pillar 158 at the second location, a request to deliver a charged battery module 136 to the charging pillar 158. In some embodiments, the charging pillar 158 may include the computing device. In other embodiments, the computing device may be a computing device of a user associated with the electric vehicle connected to the charging pillar 158, and the request may be obtained through a user interface or application displayed on a screen of the user's computing device. For example, the interface may be displayed on a mobile computing device of the user. The request may include the location of the specific charging pillar 158 associated with the request. In other embodiments, the request may include an identifier that may correspond to the location of the charging pillar 158.

At 308, the method 300 includes electrically connecting the system 100 to the charging pillar 158. Once the battery 116 is charged to an adequate level to perform the charging operations to charge the electric vehicle battery, the system 100 and the control module 132 maps a course from the charging hub 156 to the charging pillar 158 associated with the charge request. The system 100 navigates from the charging hub 156 to the charging pillar 158 while detecting and identifying objects during the navigation between the two locations. Once at the charging pillar 158, the system 100 moves towards a complementary connector interface in a direction to allow the docking port 168 to connect to the charging pillar 158. Once connected, at 310, the method 300 includes charging the electric vehicle battery through the docking port 168 by discharging the battery 116. Once the charge request is fulfilled, or terminated, the system 100 maps a course to return to the charging hub 156 or, depending on the charge level remaining in the battery 116, maps a course to another charging pillar 158 and moves to that location from its current location.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the use of the term “automatic” may involve fully automatic or semi-automatic implementations involving user or operator control over certain aspects of the implementation, depending on the desired implementation of one of ordinary skill in the art practicing implementations of the present disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

What is claimed is:

1. A robot apparatus comprising:
a docking port;
a vision module;
a battery module comprising:
a battery configured to store electrical power to charge an electric vehicle battery;
a drive module comprising:
one or more drive wheels, and
one or more motors,
wherein each motor of the one or more motors is connected to a drive wheel of the one or more drive wheels; and
a control module comprising:
a processor, and
a non-transitory computer readable medium having stored thereon instructions executable by the processor to perform operations including control one or more other modules of the robot apparatus.

2. The robot apparatus of claim 1, wherein the control module controls the one or more other modules of the robot apparatus to perform operations comprising:
electrically connect the docking port to a charging hub 156 at a first location, charge the battery with the charging hub 156,
navigate between the charging hub 156 at the first location and a charging pillar 158 at a second location remote from the first location,
electrically connect the docking port to the charging pillar 158, and discharge the battery to charge the electric vehicle battery.

3. The robot apparatus of claim 1, wherein the vision module comprises:
one or more sensors.

4. The robot apparatus of claim 3, wherein the one or more sensors are configured to emit light pulses and detect objects in an area surrounding the robot apparatus based on the emitted light pulses.

5. The robot apparatus of claim 3, wherein the one or more sensors comprises: one or more cameras configured to capture images of a scene of an area surrounding the robot apparatus to detect for objects.

6. The robot apparatus of claim 1, wherein the drive module further comprises:
a drive battery,
wherein the drive battery powers the drive module, vision module, and control module to enable the robot apparatus to move between a charging hub 156 and a charging pillar 158 when the battery in the battery module is depleted.

7. The robot apparatus of claim 1, wherein the drive module further comprises:
a motor controller,
wherein the one or more drive wheels comprises:
a first drive wheel, and
a second drive wheel, and
wherein the one or more motors comprises:
a first motor connected to the first drive wheel, and
a second motor connected to the second drive wheel,
wherein the motor controller controls operation of the first motor and the second motor to enable the robot apparatus to move in one or more directions and to turn within a turning envelope.

8. The robot apparatus of claim 7, wherein the drive module further comprises:
one or more caster wheels,
wherein the one or more caster wheels enables the robot apparatus to turn with a reduced turning envelope.

9. The robot apparatus of claim 8, wherein the one or more caster wheels comprises:
a first pair of caster wheels located on a first side of a drive axis defined by the first drive wheel and the second drive wheel, and
a second pair of caster wheels located on a second side of the drive axis opposite the first side.

10. An energy delivery device comprising:
a docking port;
a vision module comprising:
one or more sensors configured to detect for objects in an area surrounding the energy delivery device;
a battery module comprising:
a battery,
wherein the battery is electrically connected with the docking port and the battery is configured to store electrical power to charge an electric vehicle battery;
a drive module comprising:
a motor controller,
one or more drive wheels, and
one or more motors,
wherein each motor of the one or more motors is connected to a drive wheel of the one or more drive wheels; and
a control module comprising:
a processor, and
a non-transitory computer readable medium having stored thereon instructions executable by the processor to control an operation of the energy delivery device and to perform operations including:
electrically connect the docking port to a charging hub 156 at a first location,
charge the battery with the charging hub 156,
navigate between the charging hub 156 at the first location and a charging pillar 158 at a second location remote from the first location,
electrically connect the energy delivery device to the charging pillar 158, and
discharge the battery to charge the electric vehicle battery.

11. The energy delivery device of claim 10, wherein the one or more sensors are configured to emit light pulses and detect the objects in the area surrounding the energy delivery device based on the emitted light pulses.

12. The energy delivery device of claim 10, wherein the one or more sensors comprises:
one or more cameras configured to capture images of a scene of the area surrounding the energy delivery device to detect for the objects.

13. The energy delivery device of claim 10, wherein the control module further performs operations including:
obtain electrical signal data from the one or more sensors and identify one or more objects based on the electrical signal data.

14. The energy delivery device of claim 10, wherein the drive module further comprises:
a drive battery,
wherein the drive battery powers the drive module, vision module, and control module to enable the energy delivery device to move between the charging hub 156 and the charging pillar 158 when the battery in the battery module is depleted.

15. The energy delivery device of claim 10, wherein the one or more drive wheels comprises:
a first drive wheel, and
a second drive wheel, and
wherein the one or more motors comprises:
a first motor connected to the first drive wheel, and
a second motor connected to the second drive wheel,
wherein the motor controller controls operation of the first motor and the second motor to enable the energy delivery device to move in one or more directions and to turn within a turning envelope.

16. The energy delivery device of claim 15, wherein the drive module further comprises:
a first pair of caster wheels located on a first side of a drive axis defined by the first drive wheel and the second drive wheel, and
a second pair of caster wheels located on a second side of the drive axis opposite the first side;
wherein the caster wheels enable the energy delivery device to turn with a reduced turning envelope.

17. The energy delivery device of claim 10, further comprising:
an LED matrix,
wherein the control module selectively illuminates the LED matrix and based on selectively illuminating the LED matrix, the control module signals a wake-up state, a moving state, a looking state, a turning state, a charging state, and a low battery state.

18. A robot system for moving between a plurality of locations for charging an electric vehicle battery, the robot system comprising:
a vision module comprising:
one or more sensors;
a battery module comprising:
a battery including a plurality of battery packs arranged in one or more layers configured to store electrical power to charge the electric vehicle battery;
a drive module to move the robot system between a first location and a second location comprising:
a first drive wheel,
a second drive wheel,
a first motor connected to the first drive wheel,
a second motor connected to the second drive wheel, and
one or more caster wheels,
wherein the one or more caster wheels enables the robot system to turn with a reduced turning envelope; and
a control module,
wherein the control module performs operations including controlling one or more other modules to enable the robot system to navigate between the first location and the second location and to charge the electric vehicle battery;
wherein the robot system includes a docking port to electrically connect the battery to a charging hub 156 at the first location to charge the battery and to a charging pillar 158 at the second location to charge the electric vehicle battery.

19. The robot system of claim 18, wherein the drive module further comprises:
a motor controller,
wherein the motor controller controls an operation of each of the first motor and second motor to enable the robot system to move between the first location and the second location, and
a drive battery,
wherein the drive battery powers the drive module, vision module, and control module to enable the robot system to move between the charging hub 156 and the charging pillar 158 when the battery in the battery module is depleted.

20. The robot system of claim 18, further comprising:
an LED matrix,
wherein the control module selectively illuminates the LED matrix and based on selectively illuminating the LED matrix, the control module signals a wake-up state, a moving state, a looking state, a turning state, a charging state, and a low battery state.
